(19) United States
(12) Patent Application Publication
(10) Pub. No.: US 2002/0156542 A1
(43) Pub. Date: Oct. 24, 2002

(54) Methods, devices and systems for monitoring, controlling and optimizing processes

(76) Inventor: Hill K. Nandi, Indiana, PA (US)

Correspondence Address: HENRY E. BARTONY, JR., BARTONY & HARE, SUTIE 1801, 429 FOURTH AVENUE, PITTSBURGH, PA, 15219, US

(21) Appl. No.: 09/792,238

(22) Filed: Feb. 23, 2001

(51) Int. Cl. G05B 13/02

(52) U.S. Cl. 700/30

(57) ABSTRACT

A system for implementation in a procedure in which parts are processed in processing units (for example, sintering furnaces) includes at least a first process tool operating at a first location (but not necessarily physically on location at the first location). The process tool includes a communication system to communicate with sensors and controllers used in at least a first processing unit at the first location and at least one processor in communication with the communication system and with a memory. At least one mathematical model is preferably stored in the memory. The mathematical model is adapted to calculate states of at least one parameter of the parts (for example, a physical state such as temperature, density of carbon content of parts in a sintering procedure) over time during the procedure upon execution of the mathematical model by the processor. The processor uses data provided by at least the sensors via the communication system to calculate the states. The process tool is preferably provided with or is in communication with a communication network to communicate data from the first process tool (including, but not limited to, data from the sensors, data from the controllers and the calculated states data) to at least one server located at a location different from the first location. Preferably, the processor of the first process tool uses the calculated states to adjust settings of the controllers to control the state of the at least one parameter of the parts (thereby providing a feedback control loop with direct information of the physical characteristic of the processed part). The communications network can, for example, be a global computer network such as the Internet.

### BACKGROUND OF THE INVENTION

The present invention relates to methods, devices and systems for monitoring, controlling and optimizing processes and, particularly, to such methods, devices and systems for use with manufacturing processes in which certain parameters are to be controlled within relatively narrow constraints.

Conventional practice in manufacturing process control is to specify set-points for each process parameter according to a prescribed recipe. This method commonly presents a number of difficulties. The recipes are static, and cannot adjust for real-time changes in dynamic systems. Using thermal processing as an example, dynamically changing process parameters include, for example, furnace loading configuration, part geometry and other process variables. Moreover, developing the recipes often requires extensive testing on production equipment, which wastes manufacturing capacity, generates scrap and inflates work-in-process inventory. The recipes are also equipment-specific, hampering process standardization within a single facility or across multiple facilities. The recipes are not optimal from the standpoint of cycle time, energy usage and other inputs to production. Furthermore, it is difficult to improve the process, since there is no direct feedback based on the quality of the end product. Most of these problems are a result of the basic control philosophy, which tries to regulate the properties of the end product indirectly, by managing the process environment.

It is very desirable to develop methods, devices and systems for monitoring, controlling, analyzing, improving and/or optimizing processes that reduce or eliminate the above-identified and other problems.

### SUMMARY OF THE INVENTION

In one aspect, the present invention provides a system for implementation in a procedure in which parts are processed in processing units (for example, sintering furnaces). The system includes at least a first process tool operating at a first location (but not necessarily physically on location at the first location). The process tool includes a communication system to communicate with sensors and controllers used in at least a first processing unit at the first location and at least one processor in communication with the communication system and with a memory. At least one mathematical model is preferably stored in the memory. The mathematical model is adapted to calculate states of at least one parameter of the parts (for example, a physical state such as temperature, density or carbon content of parts in a sintering procedure) over time during the procedure upon execution of the mathematical model by the processor. The processor preferably uses data provided by at least the sensors via the communication system to calculate the states.

The process tool is preferably provided with or is in communication with a communication network to communicate data from the first process tool (including, but not limited to, data from the sensors, data from the controllers and the calculated states data) to at least one server (preferably located at a location different from the first location). Preferably, the processor of the first process tool uses the calculated states to adjust settings of the controllers to control the state of the at least one parameter of the parts (thereby providing a feedback control loop with direct information of the physical characteristic of the processed part). The communications network can, for example, be a global computer network such as the Internet.

The server is preferably a computer including a server processor. The server processor is preferably in communication with at least one memory and at least one display. The server processor preferably stores data received from the first process tool in a database in the server memory. The server processor preferably processes data from the first process tool to convert the data to a processed form for analysis by at least one person remote from the first location. For example, the process server can make processed data from the first process tool available to one or more persons located at the same location as the server via the server display. For some modes of analysis, the server preferably makes processed data from the first process tool available generally in real time.

Processed data can, also for example, readily be made available to a plurality of persons at locations remote from each other via, for example, the global computer network. Preferably, such processed data is made available generally simultaneously for joint analysis. The processed data (for example, graphs or charts of dynamically changing process data) can be made available to such remote personnel generally in real time (that is, generally at the same time the process is occurring).

In one embodiment, the communication system of the first process tool communicates with sensors and controllers used in a plurality of processing units at the first location and the first process tool communicates data including, but not limited to, data from the sensors, data from the controllers and the calculated states data for each of the processing units to the server. Preferably, the server processor stores such data received from the first process tool in a database in the server memory. The server preferably includes at least one optimization tool stored in the server memory which processes at least a portion of the data in the database to improve the procedure.

The system of the present invention can also include a plurality of process tools as described above operating at different locations. For example, in one embodiment, the system also includes at least a second process tool operating at a second location remote from the location of the server and different from the first location. The second process tool includes a communication system to communicate with sensors and controllers used in at least a first processing unit at the second location and at least one processor in communication with the communication system and with a memory. Preferably, at least one mathematical model is stored in the memory. As discussed above, the mathematical model is preferably adapted to calculate states of at least one parameter of the parts over time during the procedure upon execution by the processor. Preferably, the processor of the second process tool uses data provided by at least the sensors via the communication system to calculate the states. A communication network is provided in communicative connection with the second process tool to provide data from the sensors, data from the controllers and the calculated states data to the server. The processor of the second processing tool also preferably uses the calculated states to adjust settings of the controllers to control the state of the at least one parameter of the parts. The communication system of the second process tool can also communicate with sensors and controllers used in a plurality of processing units at the second location and communicate the data from the sensors, data from the controllers and the calculated states data for each of the processing units to the server.

Preferably, the server processor stores data received from the first process tool, and data from the second process tool in a database in a server memory in communication with the server processor. The server includes at least one optimization tool stored in the server memory which processes at least a portion the data in the database to improve the procedure. Processing data fiom numerous processing units at, for example, a variety of processing plants greatly improves optimization procedures.

In one embodiment, the procedure is a heat treatment procedure. For example, the procedure can be a sintering procedure.

In another aspect, the present invention provides a method for implementation in a procedure in which parts are processed in processing units. The method includes the following steps: modeling a process occurring at least a first location and communicating data from the process to at least one server located at a location different from the first location at which the procedure takes place. The step of modeling the process includes the step of providing communication between at least one processor and sensors and controllers used in at least a first processing unit at the first location. The processor is in communication with at least one memory; and executes at least one mathematical model stored in the memory. The mathematical model is preferably adapted to calculate states of at least one parameter of the parts over time during the procedure upon execution by the processor. The processor preferably uses data provided by at least the sensors via the communication system to calculate the states. The data communicated to the server preferably includes at least data from the sensors, data from the controllers and the calculated states data. The communications network used to communicate the data can, for example, be a global computer network such as the Internet.

The processor preferably uses the calculated states to adjust settings of the controllers to control the state of the at least one parameter of the parts. As described above, a server processor communicates with at least one memory and at least one display, and the server processor preferably stores data received from the first location in a database in the server memory. The server processor preferably processes data from the first location to convert the data to a processed form for analysis by at least one person remote from the first location, for example, via the server display. For certain modes of analysis, the server preferably makes processed data from first location available generally in real time.

In one embodiment, the method further includes the step of making the processed data available to a plurality of persons at locations remote from each other via, for example, the global computer network generally simultaneously for joint analysis. The processed data can, for example, be made available generally in real time.

The communication system at the first location can, for example, communicate with sensors and controllers used in a plurality of processing units at the first location. The processor preferably communicates data from the sensors, data from the controllers and the calculated states data for each of the processing units to the server. Once again, the server processor stores data received from the first location in a database in the server memory. The server preferably includes at least one optimization tool stored in the server memory which processes at least a portion the data in the database to improve the procedure.

In another embodiment, the method further includes the steps of modeling a process occurring at at least a second location and communicating data from the process to the server. The step of modeling the process at the second location including the step of providing communication between at least one processor and sensors and controllers used in at least a first processing unit at the second location. The processor is in communication with at least one memory; and executes at least one mathematical model stored in the memory. The mathematical model is preferably adapted to calculate states of at least one parameter of the parts over time during the procedure upon execution by the processor. The processor preferably uses data provided by the sensors and the controllers via the communication system to calculate the states. The data communicated to the server from the process at the second location preferably includes, for example, data from the sensors, data from the controllers and the calculated states data from the second location.

The processor operating at the second location preferably uses the calculated states to adjust settings of the controllers to control the state of the at least one parameter of the parts. Like the communication system operating at the first location, the a communication system of the second process tool can communicate with sensors and controllers used in a plurality of processing units at the second location, and the processor operating at the second location preferably communicates data from the sensors, data from the controllers and the calculated states data for each of the processing units at the second location to the server.

The server processor preferably stores data received from the first location and from the second location in a database in the server memory. The server preferably includes at least one optimization tool stored in the server memory which processes at least a portion of the data in the database to improve the procedure.

In another aspect, the present invention provides a method for providing remote analysis in a procedure in which parts are processed in processing units. The method includes the steps of:

providing at least a first process tool at a first location at which at least one processing unit is located, the first process tool providing communication between at least one processor and sensors and controllers used in the at least one processing unit, the processor communicating data from the processing tool including data from the sensors and data from the controllers to at least one server located at a location different from the first location, the server including a processor;

processing the data from the first process tool with the server processor to convert the data from a first process tool to a form for analysis; and

providing processed data to at least one person at a location remote from the first location for analysis.

In one embodiment, the method also includes the step of generally simultaneously communicating processed data to at least two people at locations remote from each other for joint analysis (for example, via a global computer network such as the Internet). In several embodiment, at least one software tool (for example, a simulation tool) is stored in a memory in communication with the server processor and is made available to persons remote from the server via, for example, the global computer network. The method can also include the step of generally simultaneously communicating processed data to at least two people at locations remote from each other for joint analysis (for example, via a global computer network such as the Internet). Processed data can, for example be provided generally in real time to the person(s) remote from the first location. Remote persons can provide analysis of processed data to at least one person at the first location.

Even merely supervisory process data such as controller set points and sensor readings can be valuable for remote analysis. For example, such data can be used to ensure that control of various processing units (at a single location or at multiple locations) is uniform. However, the first process tool is preferably in communication with at least one memory and executes at least one mathematical model stored in the memory to calculate states of at least one parameter of the parts over time during the procedure as described above. The processor preferably using data provided by at least the sensors via the communication system to calculate the states. The data communicated from the first process tool to the server preferably includes data of the calculated states. The process tool can communicate with sensors and controllers of a plurality processing units at the first location and communicate data from the plurality of processing units to the server.

The server processor preferably stores the data from the process tool in a database in memory in communication with the server processor. In that regard, the method preferably further includes the step of executing an optimization tool processing at least a portion of the date stored in the database to improve control of the procedure.

In another embodiment, the method further includes the steps of: providing at least a second process tool at a second location at which at least one processing unit is located. The second process tool provides communication between at least one processor and sensors and controllers used in the processing unit. The processor is in communication with at least one memory and executes at least one mathematical model stored in the memory. The mathematical model is preferably adapted to calculate states of at least one parameter of the parts over time during the procedure upon execution by the processor. As described above, the processor preferably uses data provided by at least the sensors to calculate the states. The processor of the second process tool communicates data from the processing tool including, for example, data from the sensors, data from the controllers and data of the calculated states to the server.

The server processor preferably stores the data from the first process tool and the second process tool in a database in memory in communication with the server processor. The method preferably also includes the step of executing an optimization tool using at least a portion of the date stored in the database (from a plurality of processing tools) to improve the procedure.

On or more of the process tools can be altered as a result of the optimization to improve the operation thereof. For example, settings and/or control methodologies for controllers can be altered as a result of the optimization. In one embodiment, the server processor can, for example, communicate the altered controller settings to at least one of the process tools to update that process tool. Processing unit maintenance schedules (for example, maintenance and/or replacement of sensors and/or controller) can also be improved as a result of, for example, statistical analysis routines.

In contrast to currently available supervisory and/or control systems and methods, the systems and methods of present invention preferably determine the properties of the manufactured product itself throughout the processing cycle. The systems and methods of present invention preferably use these properties to continuously generate process set-points (for example, a furnace setting such as temperature in a sintering process) in real time. The systems and methods of the present invention preferably also calculate set-points that are optimal for production. In the case of a sintering process, these set-points can be optimal in terms of, for example, cycle time, energy usage and other inputs to production. Rather than iterative testing on production equipment, the systems and methods of the present invention utilize mathematical modeling of the process and the product to ensure satisfactory, and preferably optimized, results.

Unlike currently available supervisory and/or control systems and methods, the systems and methods of the present invention also preferably record the process data (and also preferably product data) and readily distributes the data to remote locations/personnel for purposes of process standardization and expert consultation in process improvement. Forming a database of process data from numerous data sources greatly improves optimization efforts.

### BRIEF DESCRIPTION OF THE DRAWINGS

FIG. 1A illustrates an example of a generated furnace temperature profile and the calculated temperature profile of parts being sintered in a continuous furnace sintering process.

FIG. 1B illustrates an embodiment of an input screen for inputting process set points and other process information into the process supervisory, modeling and control system of process tool of the present invention.

FIG. 1C illustrates an embodiment of a graphical representation of a sintering furnace overview.

FIG. 1D illustrates a calculated part density profile based upon the furnace temperature profile of FIG. 1A and the other process parameters set forth in FIG. 1B.

FIG. 1E illustrates a calculated part carbon profile based upon the furnace temperature profile of FIG. 1A and the other process parameters, for example, as illustrated in FIG. 1B.

FIG. 2 illustrates a data flow diagram for an embodiment of a process tool of the present invention.

FIG. 3 illustrates an embodiment of a data retrieval, sharing and analysis tool or system for use with the process tool of FIG. 2.

FIG. 4 illustrates a sequence diagram for a sintering process.

FIG. 5 illustrates an embodiment of a system of the present invention including a process tool, a data retrieval, sharing and analysis tool and an optimization tool.

FIG. 6 illustrates another implementation of an embodiment of a system of the present invention in a thermal treatment process carried out in multiple furnaces and multiple sites.

### DETAILED DESCRIPTION OF THE INVENTION

In the present invention, at least a portion of a process (for example, a manufacturing process) is preferably controlled, in part, by first mathematically modeling the state of at least one parameter of the article (or a portion of the article) being changed (for example, manufactured or treated) in the process (or a portion of the process) using, for example, fluid dynamics, heat transfer and mass transfer continuum equations as known in the art. The example of thermal processing of a powder metal article or part is used herein as a representative example of such a process to describe an embodiment of a system of the present invention. As clear to one skilled in the art, however, the present invention has wide applicability to other processes including, for example, circuit board manufacturing (wherein solder pastes are melted in a reflow ovens to be attached to electronic chips), heat treatment processes in general, chemical vapor deposition (CVD), semiconductor crystal manufacturing, and various electrochemical plating processes.

Process Tool or Process Supervisory, Modeling and Control System

In one embodiment of the present invention, thermal treatment or processing of, for example, a powdered metal article is controlled based upon the properties and conditions of the material, article or part being processed. To produce powder metallurgical articles or parts, a series of process steps are typically required. First, the metal powder is pressed into a desired form sometimes referred to as a green part. Next, the resultant brittle green parts are sintered in a continuous or batch furnace wherein the green parts are transformed into generally coherent solid parts. In a continuous furnace, the parts typically move on a conveyor. The parts are loaded in one end of the continuous furnace and are discharged from the other end. The continuous furnace is divided into zones and the settings in each zone are maintained separately. In a batch furnace, the parts do not move. In that regard, the parts are put inside the batch furnace one batch at a time and taken out when the processing completes. The settings or set-points inside the batch furnace are the same over the volume of the furnace and are varied with time.

Sintering is a complex process in the production of powder metallurgical parts. It has a governing effect on the properties of a powder metallurgical compact. The properties change as the compact moves from one temperature to the other. With the increase in the degree of sintering, the strength, hardness, ductility, thermal conductivity, electrical conductivity and corrosion strength improve.

A powder metallurgical sintering process is dependent, for example, on time, temperature, atmospheric gas composition, flow rate, initial density, material, particle size and heating rate. In case of a continuous belt furnace, the powder metallurgical compacts undergoing sintering process encounter different temperatures and gas compositions at different areas of the furnace and preferably move at a certain speed to facilitate controlled, uniform heating. Since the final properties of the parts are direct functions of the heating environment existing in a sintering furnace, monitoring and controlling these parameters is important and essential. Monitoring and controlling each of these parameters precisely is inevitable to achieve desired results. Process supervision and control becomes even more important to attain the desired production rate.

It is clear from the above description that maintaining optimal parameters is highly desirable for attaining desirable properties in the finished product. Determination of optimum furnace settings is currently considered to be an art. Under current practices, acceptable settings can be attained only by trial and error, which results in non-uniform quality, high material rejection, high fuel consumption, wasted production time and build up of work-in-process inventory. Moreover, there is no way in current control schemes to determine abrupt changes in the parts resulting from abnormalities in the furnace or furnace accessories. In general, problems can be determined under current methods only when the parts exit the furnace and are examined.

In the system of the present invention, a mathematical model or models (that is, a process model) assist in calculating acceptable, and preferably generally optimum, process settings by solving the equations governing the process physics. In the exemplary sintering process of the present invention, several important furnace parameters can be defined as follows:

1. Time at Temperature. As used herein, time-at-temperature refers to the sintering time, which is the minimum time for maintaining the molded parts' average temperature above the sintering temperature.

2. Sintering Temperature. As used herein, sintering temperature refers to the temperature at which bonding of the powder metal takes place.

3. De-lubrication Temperature. As used herein, de-lubrication temperature refers to the temperature at which the lubricants used in the powder escapes the powder parts.

4. Process gas mixture. As used herein, process gas mixture refers to the makeup/concentrations of the gas mixture used in the furnace.

5. Cooling time. As used herein, cooling time refers to the total time the parts are cooled inside the cooling zones after the completion of the sintering process

6. Cooling rate. As used herein, cooling rate refers to the rate of change of the cooling of the parts.

Furnace parameters in zones of a continuous sintering furnace are, for example, preferably directly determined by real time computation using linear programming as known in the art. Linear programming refers generally to the process of creating programs that find optimal solutions for systems of equations (composed of linear functions) in which there are not sufficient terms for a straightforward solution. When using this method there are sets of constraints and an objective function. Examples of such constraints include, for example, 1) the mean body temperature of the parts at strategic locations inside the furnace, should be higher than or equal to the estimated or target temperature of the parts at those locations; 2) the (ΔT) temperature difference between the coldest and hottest spot should be less than a certain estimated or target value; 3) each control zone operating temperature should be within a prescribed limit; and 4) temperature difference between two adjacent zones should be within a prescribed limit.

The above constraints can be represented mathematically. In addition to the above constraints, an objective function can be formulated with the purpose of maximizing efficiency. An objective function is a function that either minimizes or maximizes a certain quantity, usually profit or cost. For example, in a conventional linear programming problem of trucking or distribution system, an objective function can be a function minimizing shipping cost. In the present example of thermal processing of sintered parts, the objective function can be formulated to minimize the cost of heating the parts. The determination of the zone parameters in the present example defines a linear programming problem wherein the control variables are the changes in the zone parameters. The solution is obtained easily in real-time.

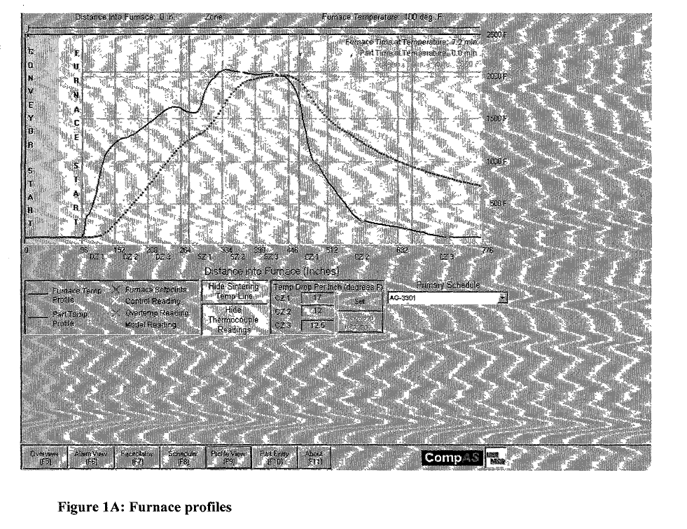

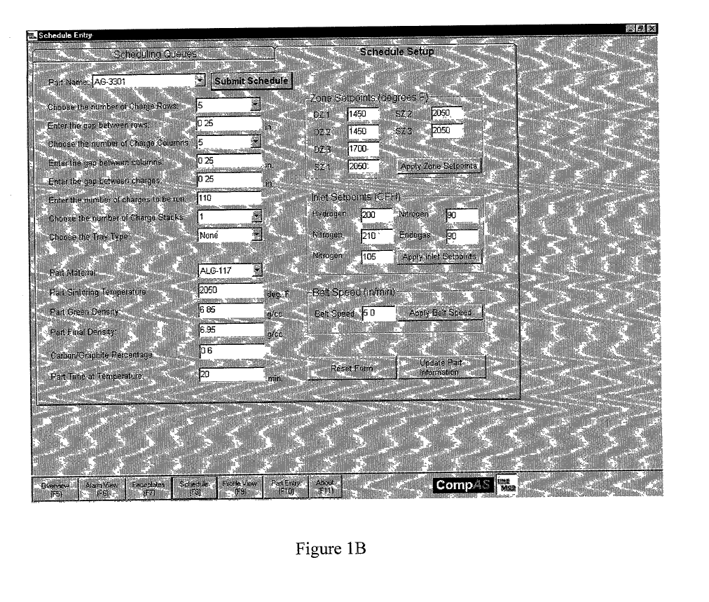

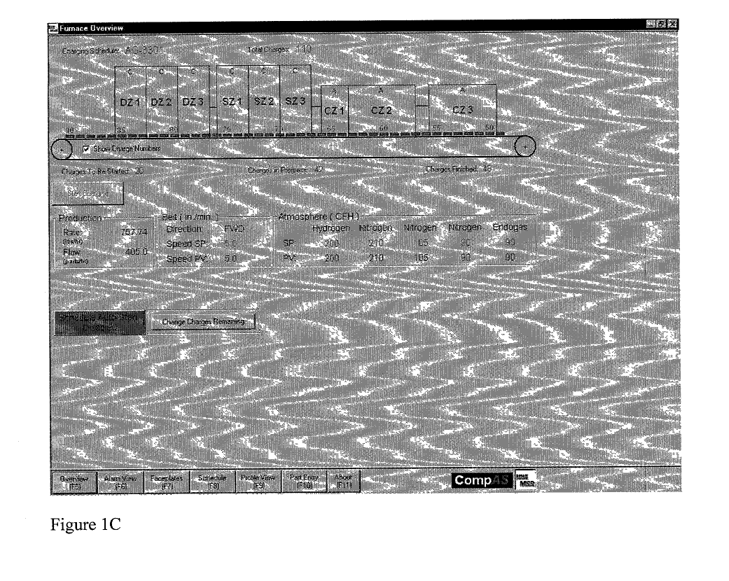

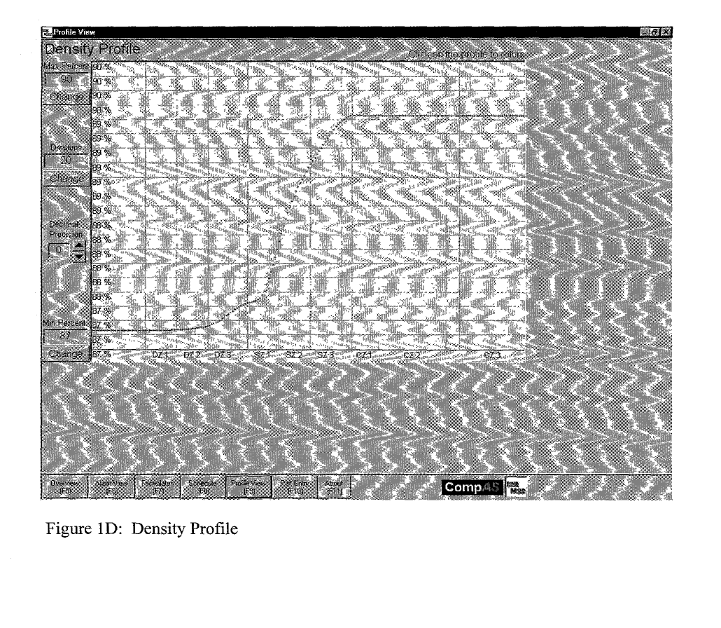

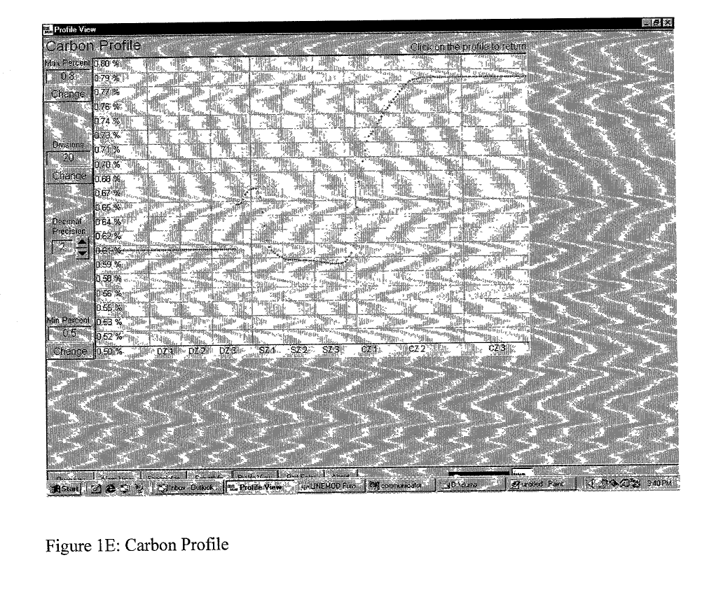

The mathematical model(s) of the process tool or process supervisory, modeling and control system of the present invention constantly (as allowed by processor speed) track the changes occurring inside the parts by solving time dependent continuum equations using the boundary conditions attained from the control equipment. The process of generating a continuous boundary condition is referred to herein as profile generation. In this process, the system reads actual data points from sensors (for example, thermocouples, flow meters and speed sensors) located at various locations along the furnace length. Subsequently, these points are fitted with a curve (spline or cubic spline) from one end of the furnace to the other to provide a continuous boundary condition over the length of the furnace. As clear to one skilled in the art, increasing the number of sensor/data points improves the accuracy of the generated profile. Preferably, as many sensors as practical are used. A typical generated temperature profile is shown in FIG. 1A. This temperature profile provides a continuous temperature boundary condition over the zones of the furnace for use in solving the continuum problems discussed below. Other sensors can be used to generate profiles for other process parameters or variables as required.

The continuum problems that are solved by the mathematical models of the process tool of the present invention for heat and mass transfer calculations are usually formulated in terms of governing partial differential equations. Heat transfer, mass diffusion and fluid flow problems, which arise in the analysis of conduction, diffusion, and convection processes, can be represented by a general transport equation as shown below:

$$γ \frac{\partial φ}{\partial t} + β ∇ \cdot ( v φ ) - ∇ \cdot ( Γ ∇ φ ) - \dot{s} = 0$$

wherein φ is an unknown parameter, t is time, γ, β, Γ: are known specific properties, v is velocity vector, and \dot{s} is volumetric source rate.

In addition to the governing differential equations, the appropriate boundary conditions must be specified to complete the formulation of the problem. Three types of boundary conditions are used in the models of the present invention as follows:

φ=φₚ is boundary condition of a first type;

−Γ∇φ·n=qₚ″ is boundary condition of a second type, where qₚ″ is the normal component of flux;

−Γ∇φ·n=h(φ−φ_{c}) is the boundary condition of a third type, where h is the convection coefficient.

Appropriate initial conditions must also be provided in the process model. The form of the initial condition in the present model is, for example:

φ=φ₀

Continuum equations as described above can, for example be solved to calculate the the temperature of the part and carbon content of the ferrous parts undergoing a heat treatment (for example, a sintering) procedure or process. In general, sintering is the process of densification for a powder compact achieved through heating without melting. The high temperatures (usually greater than one-half the melting temperature) activate diffusive mechanisms which cause a powder to densify. A mathematical sintering model, originally developed by Ashby, including the effects of grain boundary and volume diffusion was implemented in one embodiment of the process tool of the present invention in tracking density changes within parts treated in a continuous sintering furnace. See, for example, Ashby, M. F., Acta Metall., 22, 275 (1974), and Swinkel, F. B and Ashby, M. F., Acta Metall., 29, 259 (1981), the disclosures of which are incorporated herein by reference. The model also accounts for generally accepted stages of sintering that reflect large changes in the shape and distribution of the porosity in the powder compact.

Following the conventions used by the model of Ashby, as the initial powder packing densities, the nature of the porosity changes. Stage I (Δ≦0.92) is characterized by long interconnected channels of porosity and the necks between particles are still distinct. Stage II (Δ>0.92) is typically considered to have individual, isolated porosity and the necks between particles are not distinguishable.

The driving force terms for the above sintering mechanisms within each stage are defined below. These equations are used to develop expressions for the densification of the powder compact. Therefore, the driving force equation for stage I is given by

$${\tilde{F}}_{1} = [ ( P - {P}_{0} ) + 3 {Δ}^{2} ( \frac{2 Δ - {Δ}_{0}}{1 - {Δ}_{0}} ) \frac{γ}{R} ] \frac{Ω}{kT}$$

wherein P is applied pressure (normally zero during sintering), P₀ is atmospheric pressure, Δ is relative density, Δ₀ is initial relative density, γ is surface free energy, R is particle radius, Ω atomic volume, k is Boltzmann's constant, and T is absolute temperature.

Similarly, the driving force equation for stage II is

$${\tilde{F}}_{2} = [ ( P - {P}_{1} ) + 2 {( \frac{6 Δ}{1 - Δ} )}^{1 / 3} \frac{γ}{R} ] \frac{Ω}{kT}$$

wherein P₁ is internal pore pressure.

The overall densification rate of a powder compact can then be expressed using the driving force terms. The densification rate is derived by calculating the rate of mass diffusion from the particle contact areas to either the free surfaces (stage I) or to closed porosity (stage II). After performing such an analysis, the densification rate for stage I is

$$\dot{Δ} = 43 ( \frac{1 - {Δ}_{0}}{Δ - {Δ}_{0}} ) \frac{( δ {D}_{b} + 3 ρ {D}_{v} / 4 )}{{R}^{3}} {\tilde{F}}_{1}$$

wherein δ is grain boundary thickness, D_{b} is a grain boundary diffusion coefficient, ρ is equivalent to R(Δ−Δ₀) or the curvature of the neck between particles and Dᵥ is a volume diffusion coefficient.

Again, in a similar fashion, the densification rate for stage II is given as

$$\dot{Δ} = \frac{4 ( δ {D}_{b} + 3 {rD}_{v} / 4 )}{{R}^{3}} {\tilde{F}}_{2}$$

wherein

$$r = {R ( \frac{1 - Δ}{6 Δ} )}^{1 / 3} = Pore radius$$

A representative example of application the process tool of the present invention incorporating the above mathematical models to a sintering process is provided below.

### EXAMPLE

Company A produces a sintered part. As discussed above, powdered metal is first pressed into green parts. The next step is to sinter the green parts in a sintering furnace to form the finished product. These sintering furnaces are either batch or continuous as described above. These parts go through several temperature cycles before they attain the desired physical properties. The sequence of operation in the sintering furnace is generally as follows. Furnace parameters (for example, zone temperature, atmosphere gas flow, and belt speed) are first set. The green parts are then placed inside the furnace in which they are processed. The processed parts then exit the furnace.

Table 1 lists typical parameters in a sintering furnace having three delubrication (“delub”) zones, three sintering (“sinter”) zones and three cooling (“cool”) zones. The process controller set points and other process parameters (including, for example, zone temperature, sintering temperature, gas flow rates, belt speed, green part density etc.) are entered into the process tool using any suitable input device (for example, a keyboard) and, for example, a Graphical User Interface as illustrated in FIG. 1B. FIG. 1C illustrates an overall furnace view graphic for this example.

TABLE 1

| | Temp. | Gas-Flow H₂ | Gas-Flow N₂ | Belt Speed |
|---|---|---|---|---|
| Zones | (° F.) | (cubic feet/hr) | (cubic feet/hr) | (inch/min) |
| Delube | 1450 | 200 | 210 | 5.0 |
| Zone 1 | | | | |
| Delube - | 1450 | 200 | 210 | 5.0 |
| Zone 2 | | | | |
| Delube - | 1700 | 200 | 210 | 5.0 |
| Zone 3 | | | | |
| Sinter - | 2050 | 200 | 105 | 5.0 |
| Zone 1 | | | | |
| Sinter - | 2050 | 200 | 105 | 5.0 |
| Zone 2 | | | | |
| Sinter - | 2050 | 200 | 105 | 5.0 |
| Zone 3 | | | | |
| Cool - | 1000 | 200 | 90 | 5.0 |
| Zone 1 | | | | |
| Cool - | 400 | 200 | 90 | 5.0 |
| Zone 2 | | | | |
| Cool - | 100 | 200 | 90 | 5.0 |
| Zone 3 | | | | |

FIG. 1A illustrates the furnace temperature profile (continuous boundary condition) generated from the measured operating parameter resulting from the settings of Table 1. The calculated temperature profile of the sintered part is also illustrated in FIG. 1A, represented by a dashed line. FIGS. 1D and 1E illustrate the calculated density profile and the calculated carbon profile, respectively. The equations used in calculating the density profile are derived above, and one embodiment of computer code used in calculating the density profile and the other profiles are set froth in the Computer Program Listing at the end of the specification.

Although skilled operators can generally run the operation smoothly and produce quality parts over periods of time, numerous things can go wrong (for example, as a result of thermocouple deterioration, the temperature of a zone may not attain the desired temperature, or belt speed may slow without the notice of the operator(s)) for which even skilled operators cannot compensate adequately. Moreover, running the operation as described above does not generally approach optimality. The problems and limitations that are encountered by running an operation without a process tool as described in the present invention include the following: the parameters may not be set or remain optimal (for example, the belt speed from the above example could be set to 5.5 inch/min thereby increasing the throughput by 10%), the changes occurring inside the parts during processing are generally unknown—process and product problems can only be detected once the parts exit the furnace, and the real-time process and product data can not be archived and analyzed.

The problems described above can be reduced or eliminated using the systems and process tools of the present invention. The mathematical models of the process model of the present invention determine the optimum setup parameters (e.g., temperature, cycle time, and process gas) that will lead, for example, to higher throughput and lower utility consumption. The parts are tracked continuously during the sintering cycle using the process tool. The parameters or states of the parts that are tracked/calculated include, for example, the physical locations of the parts, the temperature of the parts, the density of the parts, and carbon content for ferrous parts.

From the tracked parts parameters/states, feedback is provided to the control equipment of the furnace so that furnace set points can be adjusted base upon predetermined relationships/models set forth in the process tool of the present invention.

Product or process abnormalities can be corrected automatically using the process tool of the present invention by, for example, changing downstream furnace set points. Additionally, the process tool of the present invention can also be operated in a “manual mode,” enabling the operators to detect product or process abnormalities and rectify such abnormalities “manually” before the parts exit the furnace. For example, using the process tool of the present invention, the operator can view the transformation of the parts on a continuous basis. For example, the operator can view (via, for example, a computer monitor) the temperature of the parts, the density of the parts, and the carbon content of parts at any location inside the furnace. If the operator observes any abnormalities in one or more properties of the parts, the operator can immediately take action to change zone settings to remedy such problems. For example, the operator may change zone temperatures in the downstream zones. Moreover, the operator can also identify the problem(s) causing the abnormalities and rectify the problem(s). Without the process tool of the present invention, the operator cannot detect such problems before the parts exit the furnace, and at that time, it is too late to salvage bad parts.

Process data is preferably archived for future analysis using the process tool. To archive the process data, the furnace controllers are preferably connected with data acquisition software within the process tool.

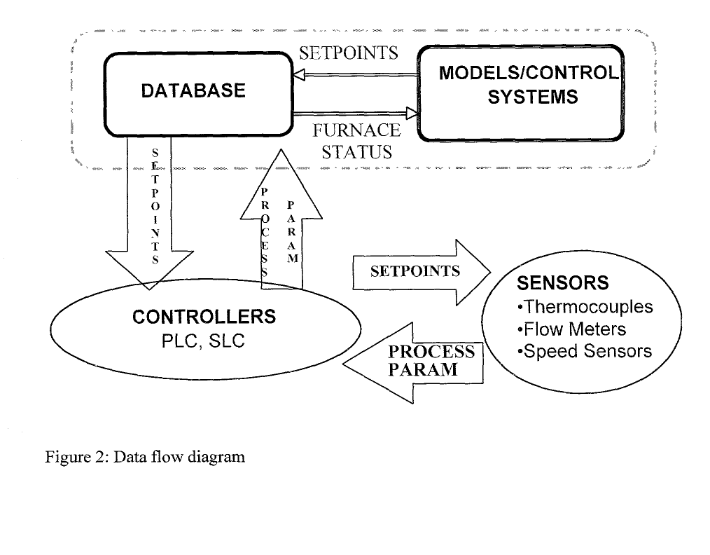

FIG. 2 illustrates an embodiment of the process tool of the present invention, which provides all the features of what is sometimes referred to as supervisory control and data acquisition (SCADA) software. Like currently available supervisory control and data acquisition systems the process tool of the present invention preferably communicates directly with the controllers. This direct communication facilitates writing set-points to and reading process variables from the furnace controllers. However, unlike currently available SCADA software, the process tools of the present invention calculate the transformation taking inside the parts to define the states of one or more parameters (for example, temperature, density etc.) of the parts throughout (preferably, generally continuously throughout) the process. Therefore, in addition to archiving process data, the process tool of the present invention is capable of archiving changes inside the product. The calculation of such product information facilitates better control of the process by using these parameters as feedback in the system to appropriately adjust furnace set points.

Preferably the information collected/archived at the factory floor is also transmitted to one or more central data collection/sharing and analysis site using, for example, a wide area network or other network (for example, the Internet). The present invention thereby also provides an overall method of building and selectively distributing a process-specific knowledge base, which permits continuous improvement of the process of procedure and the process tool.

Data Retrieval/Sharing and Offsite Analysis

Monitoring and controlling of a real-time process can be achieved with, for example, onsite desktop computers implementing the process tool of the present invention. However, computers and models alone cannot supervise a manufacturing process entirely. Human supervision and intervention is desirable to effectively trouble-shoot process related problems. This supervision could be provided by engaging dedicated personnel for onsite process supervision. However, the personnel assigned to this task are not only preferably experts in all facets of the process, but are also preferably familiar with the control systems and the mathematical models existing in the process tool software. In the marketplace, it is difficult for small to mid-sized (and even large) companies to engage a dedicated person or persons to perform these tasks.

The present invention thus preferably provides remote process supervision, analysis and/or consulting by retrieving at least a portion of (and preferably substantially all of) the process data (static as well as dynamic production data) from the production floor and transmitting the data to one or more offsite servers. The following tasks can, for example, be performed remotely in the present invention: 1) Monitoring the real-time process over a network such as the Internet; 2) Generating reports remotely of the process performance; 3) Diagnosing equipment failure and providing pre-breakdown alarms; 4) Providing preventive maintenance scheduling of equipment; 5) Allowing the user to use a process simulator and other mathematical tools over the network connection and 6) Using the retrieved process and product data to calibrate and fine tune, for example, mathematical models of the process tool, the control algorithms of the process tool, and/or the starting materials used in the process. The process information can also, for example, be displayed over an Internet site in a manner suitable for analysis. Preferably the process data is made available generally simultaneously to a plurality of persons at locations remote form each other, thereby enabling joint analysis, consultation and problem solving. Such process information is preferably generally provided in real time for certain types of analysis.

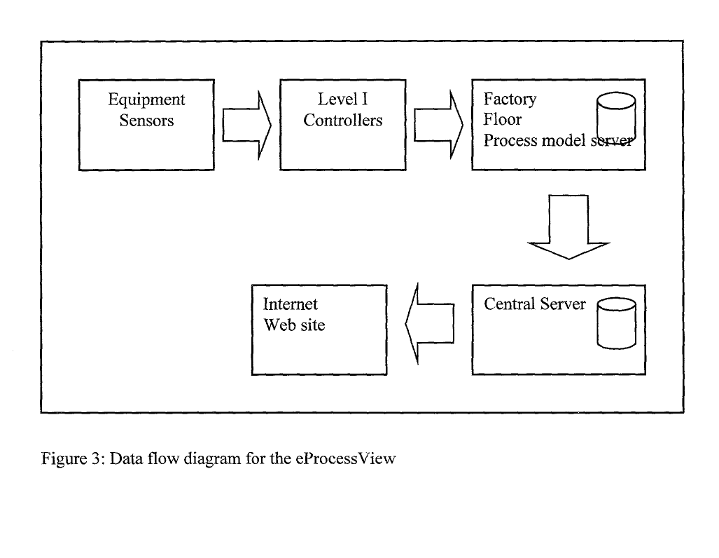

FIG. 3 illustrates one embodiment of a system of the present invention. Real-time data (both static and dynamic) from the level-I controllers (for example, SLC (single loop controller), PLC (programmable logic controller) or other I/O devices) flows to the database residing in the plant floor servers. In this embodiment, these data are then sent to a main/central server at an offsite center through the Internet. Process information can also be displayed via an Internet site in a readily analyzable format (preferably, suitable for viewing via a standard web browser).

### EXAMPLE

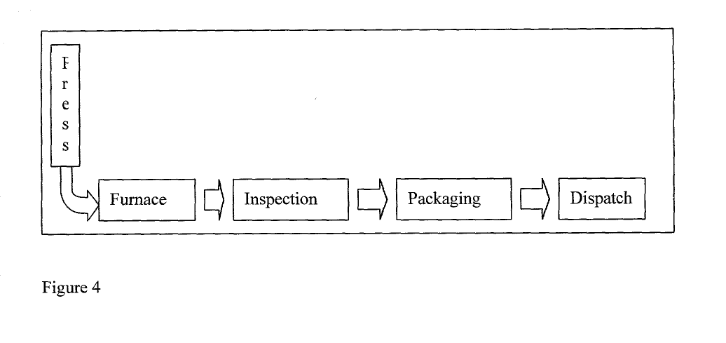

Company A operates several sintering furnaces to sinter pressed parts as discussed above. The sequence of operation is shown in FIG. 4. As discussed above, the powder is compacted in a press to form green parts. These green parts are then sintered in sintering furnaces including several heating and cooling zones. As described above, the purpose of the sintering the green parts is to impart desired properties inside the parts as the parts go through transformation. As also discussed above, the final qualities of the finished product depend on several factors including, for example, quality and blending of the incoming powder, the pressing operation and the sintering operation.

The process tool or program of the present invention constantly gathers real-time process data e.g., zone temperatures, controller output, process speed, process gas flow, cooling water temperature, cooling water flow, oxygen, dew point, part temperature, part density, and part carbon content for ferrous parts. These data are then sent to the central server via either a wired or wireless network such as the Internet by, for example, subscribing an IP (Internet Protocol) address for the furnace server running the process tool software. The real-time data is preferably stored in a database of the central server located offsite from the factory floor/processing plant.

An application (for example an application or applet in the JAVA® operating system of Sun Microsystems, Inc. of Palo Alto, Calif.) inside the system of the present invention preferably retrieves the real-time data from the database and processes the data to create plots, charts, and comparisons for analysis using methodologies known in the computer arts. One of the tasks performed by the system of the present invention is thus converting raw data into readily analyzable information, particularly for use/analysis by one or more parties remote from the site of the manufacturing process. For example, one of the important types of information in the sintering furnace is the furnace profile as shown in FIG. 1A. Quality of the sintered parts is directly correlated to the temperature profile existing inside the furnace as discussed above. If the parts do not conform to a predefined specification, the first information to examine is typically the temperature profile existing inside the furnace while the parts are sintered. Without the process tool of the present invention, it is not possible to capture an existing thermal profile. Although the process tool is capable of capturing the profile, it is not possible to view the profile from one or more remote locations without a data retrieval/sharing system in place. Simultaneous remote viewing/analysis of the process assists joint problem solving, joint process analysis, and joint trouble shooting.

In the case of analyzing a sintering process, one preferably first inspects the shape of the profile. Next, the validity of the profile is preferably be checked. If the profile looks normal, one must look further to determine what is causing the parts to not conform to specification. If the profile is skewed, one preferably determines what is causing the profile to be skewed. A faulty profile can be caused by one or more factors including, for example: design limitations of the furnace, thermocouple failure and/or problems with heating elements.

Answers to the above inquiries/inspections may not be available from a single source. Problem resolution may require input/analysis from experts having different areas of expertise and being located in different physical locations to arrive at a correct recommendation. To assist in this process, it is desirable to allow simultaneous viewing/analysis of real-time process information by several experts. The present inventions facilitates this process.

Converting the real-time process data into valuable information and then analyzing the information remotely can, for example, include: 1) transmission of real-time process and product data from the process tool server to the central server; 2) conversion of raw data to information like plots, charts, alarms, and comparison; 3) viewing the plots, charts, alarms, and comparison via, for example, a standard web browser and 4) joint problem solving by experts by viewing the process in a real-time mode.

The value of the data retrieval/sharing system of the present invention is apparent upon comparison of problem solving without it. For example, if it is assumed that company A has the process tool of the present invention to monitor and control the sintering process and not a data retrieval/sharing tool or system, one could attempt to solve problems jointly from different locations by printing static plots, charts, alarms, comparisons and transmitting them by, for example, fax or e-mail. One should note, however, that these are just snap shots and, theoretically, an infinite number of such snap shots may be required to simulate the real situation—a practical impossibility. If, however, one assumes that it is possible to transmit a sufficient number of such snap shots, the next step is to analyze each snap shot individually. If someone needs to consult another expert in a different location, it can be done, for example, over the phone by referring to the snap shots. This methodology clearly leads to significant confusion and logistical problems. If the process tool of the present invention is not available, the only way to solve the problem is to bring all the experts to the plant and to jointly monitor the process. That methodology is a viable solution only if cost is not a factor.

Data Analysis, Optimization and Process Improvement

The present invention also preferably provides an optimization system or tool to, for example, (using once again the example of a sintering process) improve throughput and product consistency, while lowering downtime, scrap, fuel and industrial gas consumption, and work-in-process inventory. In general, analytical tools are applied to the process data collected at the remote server as described above. Preventive maintenance plans can, for example, be developed based on statistical analysis of component failures across multiple furnaces for which data is present in the server database. For example, known Monte Carlo simulation methods or tools can be applied. In general, the Monte Carlo method uses the concepts of probability distribution and random numbers to evaluate system responses to various policies. For example one can 1) replace all parts of certain type (for example. thermocouples or belts) when one fails in one furnace, or 2) repair or replace all parts after a certain length of service based on an estimated average service life. Setting probability distributions for failure rates, selecting random numbers, and simulating past failures and their associated cost accomplish these results.

Another tool preferably determines the optimal profile for temperature, carbon content and other conditions in each part over the course of the heating and cooling cycle. The linear programming problems can be solved using, for example, the LINDO program available from LINDO Systems, Inc. of Chicago, Ill. The LINDO program uses the well know SIMPLEX algorithm. The resultant target part conditions can be input to the process supervisory, modeling and control system or process tool of the present invention, which adjusts furnace set-points in real time to account for changes in part geometry, furnace loading and other conditions as they occur. This methodology improves product consistency, maximizes productivity, and minimizes energy and other inputs to production.

The system and methodology of the present invention also reduces work-in-process inventory by, for example, allowing several different parts to be mixed in the same furnace run. Achieving this result is, again, a linear programming problem wherein a priority heating or cooling schedule must be solved. For example, assume there are two sets of parts to be heated. The first set includes parts with higher mass than the second set of parts. The temperature of the heating zone is preferably determined in such a manner that the heavier parts are sufficiently heated and the lighter parts are not overheated. The objective is to determine heating of the critical parts (that is, which of the two parts requires special attention). For example, if the heavier parts must be maintained at a temperature 2050° F.±20° F., and if the lighter parts must be maintained at 2000° F.±40° F., the system software or model determines the critical part, heavier parts in this example. Furthermore, the system software or model also preferably determines the optimum zone setting of about 2040° F., which is optimum to heat both of these parts. The above example is illustrative of the concept, but is simple enough to be solved by human brain. However these problems can be very complex and in many cases are not solvable by simple logic. For example, if instead of two sets of parts there are three sets of parts in one heating zone, or target temperature to be attained in a zone do not overlap. In these cases one can use computer models and simulation to determine the optimum solution as known in the art.

One of the components of the optimization tool or system of the present invention is preferably adaptive learning. To calculate the “optimal” set-point schedule, for which parts of desirable qualities are attained, an accurate prediction of zone temperature is required. In addition, it is necessary that the prediction be robust. Robustness refers to the accuracy of the prediction over a wide range of operating conditions. It is not generally sufficient that predictions be accurate for a repeatable sequence. Preferably, there is sufficient accuracy even for deviations from set conditions. Robustness allows the calculation of an optimal schedule even though operating conditions may drift significantly. One way to achieve robustness is to adopt a model based adaptive control scheme. In this scheme one attempts to compare the actual measured value with the predicted values from the model. Errors between actual and measured values are minimized by appropriately adjusting the parameters of the model.

Once again, the process tool constantly gathers real time process data (e.g., zone temperatures, controller output, process speed, process gas flow, cooling water temperature, cooling water flow, oxygen, dew point, part temperature, carbon content for the ferrous parts, and part density). The data is constantly routed to the central server over, for example, the Internet. Preferably, a database is created including data from multiple furnaces at the same or multiple locations to improve optimization. The data can come from a single company or other entity of from different entities. The optimization system allows constant archiving of these data, software analysis of the data, and suitable recommendations on how to run the process efficiently. Using a database having a multiple sources of data as a source for the optimization tool of the present invention can be thought of as creating a well traveled, highly experienced virtual consultant.

The optimization system also provides the capability to schedule preventive maintenance by analyzing the failure trends of some of the critical furnace components. In that regard, by analyzing the failure history of the control thermocouples one may, for example, determine the average life of an s-type thermocouple to be three months and the standard deviation to be one month. During the time period between three months and four months, customers can be periodically notified (for example, twice or three times per week) to inspect the status of thermocouples and also can be provided with the procedures to check the thermocouples. After four months, for example, a recommendation to replace the thermocouple may be sent. Similar recommendation can be made for other process equipment such as, for example, heating elements (glow bars), and mesh belts. Likewise, similar recommendation on how often to calibrate the controllers and perform furnace profiling can be made.

The optimization tool of the present invention preferably also enables determination of optimal furnace settings (for example, temperature, atmosphere, and throughput) for changes in the process such as new part geometries and/or new powder formulation. This optimization is preferably achieved by running the process tool off-line or simulation mode with virtually created/modeled parts. This simulation software tool can be provided to personnel at the site of the server, to onsite, processing plant personnel and/or to consultants or others in remote locations. Several combinations of settings are preferably tested to determine the final optimal settings. This optimization maximizes production throughput and minimizes energy consumption. One of the procedures for arriving at an optimum setting is described below. Although the same technique can be used for other settings, the following example considers the determination of zone set-point temperatures. When using this method there are sets of constraints and an objective function as described above. Once again, examples of such constraints include, for example, 1) the mean body temperature of the parts at strategic locations inside the furnace should be higher than or equal to the estimated or target temperature of the parts at those locations; 2) the temperature difference (ΔT) between the coldest and hottest spot should be less than a certain estimated or target value; 3) each control zone operating temperature should be within a prescribed limit; and 4) temperature difference between two adjacent zones should be within a prescribed limit.

As also discussed above, the constraints are represented mathematically and an objective function is formulated with the purpose of maximizing the efficiency to create a linear programming problem wherein the control variables are the changes in the zone parameters. The solution is obtained easily in real-time. Additionally, finite element software can be used to determine the transformation in minute detail. Examples of suitable finite element software used for this purpose are ANSYS available from Ansys Inc. of Canonsburg, Pa. and ALGOR available from Algor, Inc. of Pittsburgh, Pa.

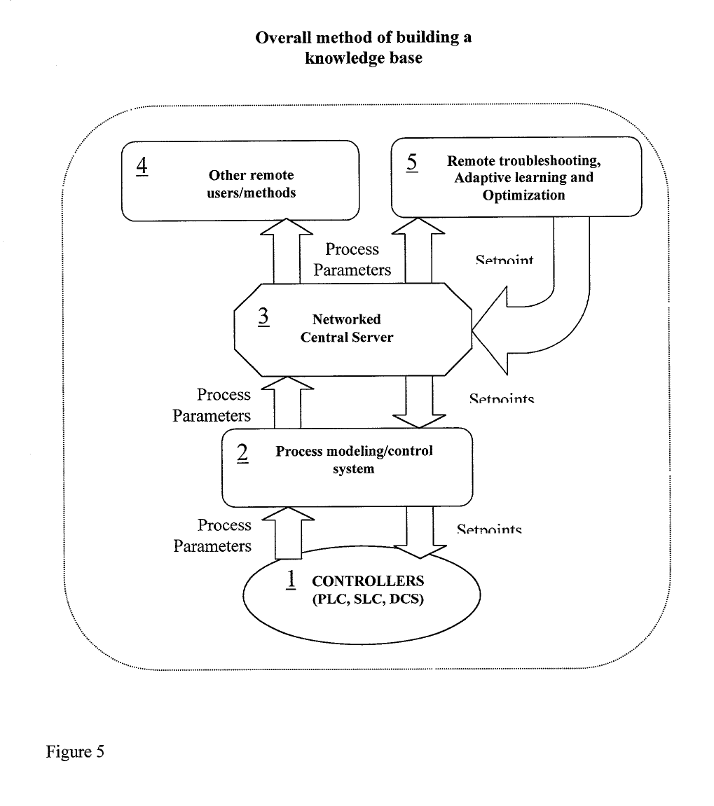

FIG. 5 illustrates one embodiment of a complete installation of several components of the present invention for a continuous-feed powder metal sintering application. To control the furnace parameters and to receive feedback on the operation of the process, the process tool preferably communicates with the furnace sensors and controllers 1. These controllers may, for example, be single loop controllers (SLC), programmable logic controllers (PLC) and/or distributed control systems (DCS). Communication is implemented based on the abilities of the furnace control devices.

The interface with the furnace controllers can be via, for example, a personal-computer based process tool 2 of the present invention, which provides all the functions of currently available supervisory control and data acquisition systems. Conventional supervisory systems augment the physical controls on a furnace by performing functions that are otherwise performed by an operator, (for example, specifying set-points and recording process variables). Unlike current SCADA systems, process tool 2 of the present invention includes mathematical models to calculate the physical condition/state of preferably each part. That is a significant advance over conventional SCADA systems, which track furnace conditions but cannot (for example, in the case of thermal processing) tell the temperature profile, carbon content, density or other properties of the part.

The next step in the overall process is to transfer data from the process tool 2 to a central computer server 3. This can, for example, be a local area server, a wide area server or an Internet server. Larger networks provide an inherently more powerful knowledge base by collecting a broader range of data from more sources, and providing information to a wider range of users 4 and 5. A single network server serving many furnaces in a single plant location or in various plant locations also makes it practical to perform more sophisticated analysis and/or optimization to synthesize information from the data. For example, a sufficiently large data base permits scheduling preventive maintenance based on statistical analysis of furnace failure history.

Thus, the present invention provides a system and method of collecting process and product data, converting it to usable information and distributing it to users. The real-time and historical data from one or more plants is preferably analyzed by off-site experts at a single or multiple locations to provide remote services including, for example: trouble shooting and preventive maintenance; optimum set-point determination, and adaptive learning.

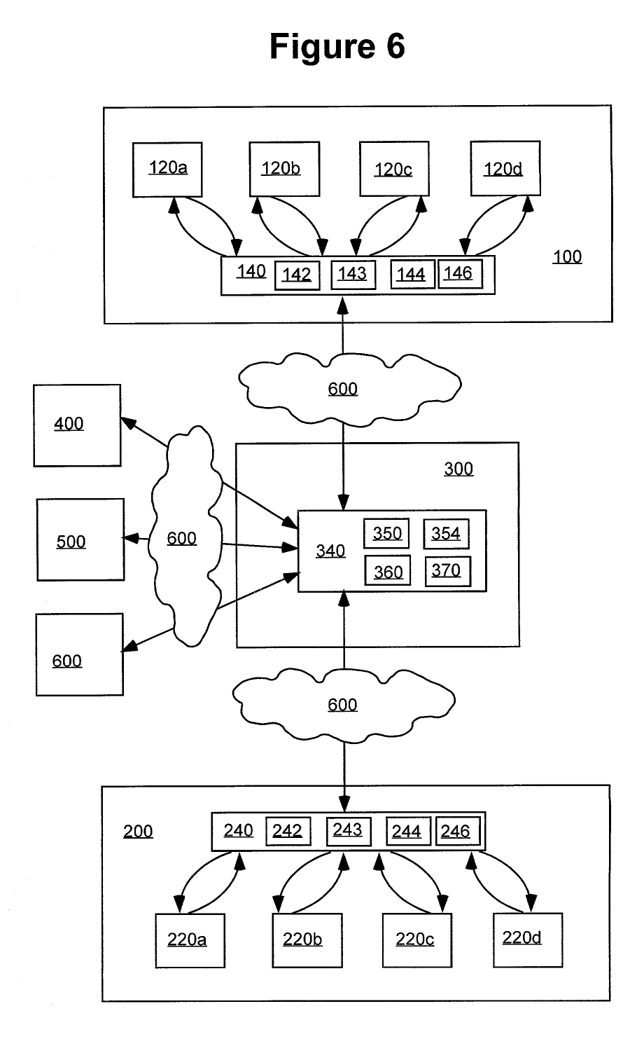

An implementation of one embodiment of the present invention is illustrated in FIG. 6 in which two processing plants 100 and 200 at separate locations operate a sintering process as described above. In processing plant 100, four continuous sintering furnaces 120a, 120b, 120c and 120d are operated. A process tool 140 is operative at processing plant 100 to measure process parameters, calculate part parameters and control the process via communication with process sensors and controllers in continuous sintering furnaces 120a, 120b, 120c and 120d as described above. Process tool 140 is preferably implemented using at least one digital computer as known in the art, including, for example, at least one processor 142 in communication with at least on input device 143, at least one memory storage device 144 (in which the process modeling and control executables can be stored) and at least one display 146. Likewise, a second process tool 240 is operative at processing plant 200 to measure process parameters, calculate part parameters and control the process via communication with process sensors and controllers of continuous sintering furnaces 220a, 220b, 220c and 220d of, for example, the same design as continuous sintering furnaces 120a, 120b, 120c and 120d. Process tool 240 is also preferably implemented using at least one digital computer as known in the art, including, for example, at least one processor 242 in communication with at least on input device 243, at least one memory storage device 244 and at least one display 246.

As described above, dynamic and static process data from process tool 140 and process tool 240 are preferably transmitted to a central computer server or servers 340 located at a site 300 that can be remote from each of processing plant 100 and processing plant 200. Server 340 is preferably a digital computer including at least one processor 350 in communication with at least one input device 354, at least one memory storage device 360 and at least one display 370. The data from process tools 140 and 240 can be transmitted using, for example, a global computer network such as the Internet 600.

Server 340 preferably processes the raw data from process tools 140 and 240 in a manner to present the data (via, for example, charts, plots, tables etc.) to expert staff for analysis. Such expert staff can be on location at site 300. Moreover, the processed data can also be transmitted in real time (via, for example, a global computer network such as the Internet 600) to remote sites 400, 500 and or 600 at which other experts can be located. It is not necessary that the raw data be processed at a single site. For example, raw data can be sent to numerous sites that have the necessary tools from processing the data.

The personnel at site 300 (and/or sites 400, 500 and 600) are preferably experts in the process being monitored/controlled and are also familiar with the control systems and the mathematical models existing in the process tools 140 and 240. Process monitoring, supervision, active control and/or analysis can be outsourced to any entity or entities at virtually any location(s) using the system of the present invention. Likewise, tools for simulating the heat treating and other processes can readily be provided to users at any site (for example, site 100, 200, 300, 400, 500 and/or 600 via, for example, the Internet 600) to perform “what-if” analyses to minimize trial runs and fine tune process operations.

Furthermore, data from many process sites can be viewed simultaneously. Simultaneous remote viewing/analysis by a plurality of people of the process assists joint problem solving, joint process analysis, and joint trouble shooting. It provides a significant improvement in efficiency over current practices in which joint problem solving requires bringing numerous experts (as either employees or independent contractors) to a particular processing site such as processing site 100 or processing plant 200. In the exemplary case of a metallurgical powder sintering process, the system of the present invention, for example, creates a platform for all relevant supply chain partners such as raw material suppliers, OEMs & equipment suppliers and thermal metal processors to get together and solve any problems associated with the process, greatly reducing the time and the expense required to resolve a quality problem.

As also described above, process optimization is facilitated with the use of remote data sharing/analysis as provided by the present invention using, for example, optimization tools known in the art. The process supervisory, modeling and control systems or process tools of the present invention as well as the control and efficiency of the process and the quality of the end product are thereby continuously improved. Receipt, storage/archiving, processing and analysis of data from multiple sites using, for example, the same or similar materials, the same or similar process equipment and/or the same or similar process conditions greatly improves such optimization efforts.

Although the present invention has been described in detail in connection with the above examples, it is to be understood that such detail is solely for that purpose and that variations can be made by those skilled in the art without departing from the spirit of the invention except as it may be limited by the following claims.

[image]

[image]

[image]

[image]

[image]

[image]

[image]

[image]

[image]

What is claimed is:

1. A system for implementation in a procedure in which parts are processed in processing units, the system comprising:
at least a first process tool operating at a first location including:
a communication system to communicate with sensors and controllers used in at least a first processing unit at the first location;
at least one processor in communication with the communication system and with a memory; and
at least one mathematical model stored in the memory, the mathematical model being adapted to calculate states of at least one parameter of the parts over time during the procedure upon execution by the processor,
the processor using data provided by at least the sensors via the communication system to calculate the states; and
a communication network in communicative connection with the first process tool to communicate data from the first process tool including data from the sensors, data from the controllers and the calculated states data to at least one server located at a location different from the first location, the server including a processor.

2. The system of claim 1 wherein the processor uses the calculated states to adjust settings of the controllers to control the state of the at least one parameter of the parts.

3. The system of claim 2 wherein the server processor is in communication with at least one memory and at least one display, the server processor storing data received from the first process tool in a database in the server memory.

4. The system of claim 3 wherein the server processor processes data from the first process tool to convert the data to a processed form for analysis by at least one person remote from the first location.

5. The system of claim 4 wherein the process server makes processed data from the first process tool available via the server display.

6. The system of claim 4 wherein the server makes processed data from the first process tool available generally in real time.

7. The system of claim 4 wherein the communications network is a global computer network.

8. The system of claim 3 wherein the communication system of the first process tool communicates with sensors and controllers used in a plurality of processing units at the first location and the first process tool communicates data from the sensors, data from the controllers and the calculated states data for each of the processing units to the server.

9. The system of claim 8 wherein the server processor stores data received from the first process tool in a database in the server memory.

10. The system of claim 2 wherein the server includes at least one optimization tool stored in the server memory which processes at least a portion of the data in the database to improve the procedure.

11. The system of claim 9 wherein the server includes at least one optimization tool stored in the server memory which processes at least a portion of the data in the database to improve the procedure.

12. The system of claim 7 wherein the processed data is made available to a plurality of persons at locations remote from each other via the global computer network generally simultaneously for joint analysis.

13. The system of claim 12 wherein the processed data is made available generally in real time.

14. The system of claim 1 further including:
at least a second process tool operating at a second location remote from the location of the server and different from the first location, the second process tool including:
a communication system to communicate with sensors and controllers used in at least a first processing unit at the second location;
at least one processor in communication with the communication system and with a memory; and
at least one mathematical model stored in the memory, the mathematical model being adapted to calculate states of at least one parameter of the parts over time during the procedure upon execution by the processor,
the processor using data provided by at least the sensors via the communication system to calculate the states; and
a communication network in communicative connection with the second process tool to provide data from the sensors, data from the controllers and the calculated states data to the server.

15. The system of claim 14 wherein the processor of the second processing tool uses the calculated states to adjust settings of the controllers to control the state of the at least one parameter of the parts.

16. The system of claim 15 wherein the communication system of the second process tool communicates with sensors and controllers used in a plurality of processing units at the second location and communicates the data from the sensors, data from the controllers and the calculated states data for each of the processing units to the server.

17. The system of claim 16 wherein the server processor stores data received from the first process tool and data from the second process tool in a database in a server memory in communication with the server processor.

18. The system of claim 17 wherein the server includes at least one optimization tool stored in the server memory which processes at least a portion the data in the database to improve the procedure.

19. The system of claim 18 wherein the procedure is a heat treatment procedure.

20. The system of claim 19 wherein the procedure is a sintering procedure.

21. A method for implementation in a procedure in which parts are processed in processing units, the method comprising the steps of:
modeling a process occurring at least a first location, the step of modeling the process including the steps of:
providing communication between at least one processor and sensors and controllers used in at least a first processing unit at the first location, the processor being in communication with at least one memory; and
executing at least one mathematical model stored in the memory, the mathematical model being adapted to calculate states of at least one parameter of the parts over time during the procedure upon execution by the processor, the processor using data provided by at least the sensors via the communication system to calculate the states; and
communicating data from the sensors, data from the controllers and the calculated states data to at least one server located at a location different from the first location at which the procedure takes place, the server including a processor.

22. The method of claim 21 wherein the processor uses the calculated states to adjust settings of the controllers to control the state of the at least one parameter of the parts.

23. The method of claim 22 wherein the server processor communicates with at least one memory and at least one display, the server processor storing data received from the first location in a database in the server memory.

24. The method of claim 22 wherein the server processor processes data from the first location to convert the data to a processed form for analysis by at least one person remote from the first location.

25. The method of claim 24 wherein the process server makes the processed data from the first location available via the server display.

26. The method of claim 24 wherein the server makes the processed data from first location available generally in real time.

27. The method of claim 24 wherein the communications network is a global computer network.

28. The method of claim 23 wherein the communication system at the first location communicates with sensors and controllers used in a plurality of processing units at the first location and the processor communicates data from the sensors, data from the controllers and the calculated states data for each of the processing units to the server.

29. The method of claim 28 wherein the server processor stores data received from the first location in a database in the server memory.

30. The method of claim 22 wherein the server includes at least one optimization tool stored in the server memory which processes at least a portion the data in the database to improve the procedure.

31. The method of claim 29 wherein the server includes at least one optimization tool stored in the server memory which processes at least a portion the data in the database to improve the procedure.

32. The method of claim 27 further including the step of making the processed data available to a plurality of persons at locations remote from each other via the global computer network generally simultaneously for joint analysis.

33. The method of claim 32 wherein the process data is made available generally in real time.

34. The method of claim 21 further including the steps of:
modeling a process occurring at at least a second location, the step of modeling the process at the second location including the steps of:
providing communication between at least one processor and sensors and controllers used in at least a first processing unit at the second location, the processor being in communication with at least one memory; and
executing at least one mathematical model stored in the memory, the mathematical model being adapted to calculate states of at least one parameter of the parts over time during the procedure upon execution by the processor, the processor using data provided by the sensors and the controllers via the communication system to calculate the states; and
communicating data from the sensors, data from the controllers and the calculated states data from the second location to the server.

35. The method of claim 34 wherein the processor uses the calculated states to adjust settings of the controllers to control the state of the at least one parameter of the parts.

36. The method of claim 35 wherein the a communication system of the second process tool communicates with sensors and controllers used in a plurality of processing units at the second location and the processor communicates data from the sensors, data from the controllers and the calculated states data for each of the processing units at the second location to the server.

37. The method of claim 36 wherein the server processor stores data received from the first location and from the second location in a database in the server memory.

38. The method of claim 37 wherein the server includes at least one optimization tool stored in the server memory which processes at least a portion of the data in the database to improve the procedure.

39. The method of claim 38 wherein the procedure is a heat treatment procedure.

40. The method of claim 39 wherein the procedure is a sintering procedure.

41. A method for providing remote analysis in a procedure in which parts are processed in processing units, the method comprising the steps of:
providing at least a first process tool at a first location at which at least one processing unit is located, the first process tool providing communication between at least one processor and sensors and controllers used in the at least one processing unit, the processor communicating data from the processing tool including data from the sensors and data from the controllers to at least one server located at a location different from the first location, the server including a processor;
processing the data from the first process tool with the server processor to convert the data from a first process tool to a form for analysis; and
providing processed data to at least one person at a location remote from the first location for analysis.

42. The method of claim 41 further including the step of generally simultaneously communicating processed data to at least two people at locations remote from each other for joint analysis.

43. The method of claim 42 wherein the processed data is communicated via a global computer network.

44. The method of claim 41 wherein at least one software tool stored in a memory in communication with the server processor are made available to persons remote from the server via a global computer network.

45. The method of claim 41 further wherein the first process tool is in communication with at least one memory and executes at least one mathematical model stored in the memory, the mathematical model being adapted to calculate states of at least one parameter of the parts over time during the procedure upon execution by the processor, the processor using data provided by at least the sensors via the communication system to calculate the states, and wherein the data communicated from the first process tool to the server includes data of the calculated states.

46. The method of claim 45 wherein the process tool communicates with sensors and controllers of a plurality processing units at the first location and communicates data from the plurality of processing units to the server.

47. The method of claim 46 further including the step of generally simultaneously communicating processed data to at least two people at locations remote from each other for joint analysis.

48. The method of claim 47 wherein the processed data is communicated via a global computer network.

49. The method of claim 46 wherein the server processor stores the data from the process tool in a database in memory in communication with the server processor.

50. The method of claim 49 further including the step of executing an optimization tool processing at least a portion of the date stored in the database to improve control of the procedure.

51. The method of claim 45 further including the steps of:
providing at least a second process tool at a second location at which at least one processing unit is located, the process tool providing communication between at least one processor and sensors and controllers used in the at least one processing unit, processor being in communication with at least one memory and executing at least one mathematical model stored in the memory, the mathematical model being adapted to calculate states of at least one parameter of the parts over time during the procedure upon execution by the processor, the processor using data provided by at least the sensors to calculate the states, the processor communicating data from the processing tool including data from the sensors, data from the controllers and data of the calculated states to the server.

52. The method of claim 51 wherein the server processor stores the data from the first process tool and the second process tool in a database in memory in communication with the server processor.

53. The method of claim 52 further including the step of executing an optimization tool using at least a portion of the date stored in the database to improve the procedure.

54. The method of claim 53 wherein at least one of the first process tool at the first location or the second process tool at the second location is altered as a result of the optimization.

55. The method of claim 54 wherein settings for controllers are altered as a result of the optimization.

56. The method of claim 55 wherein the server processor communicates the altered controller settings to at least one of the first process tool at the first location or the second process tool at the second location.

57. The method of claim 54 wherein the procedure is a heat treating procedure.

58. The method of claim 53 further including the step of developing processing unit maintenance schedules.

59. The method of claim 41 wherein processed data is provided generally in real time to the person remote from the first location.

60. The method of claim 59 wherein the person provides analysis of processed data to at least one person at the first location.

61. The method of claim 44 wherein the software tool is a simulation tool simulating the procedure in the at least one processing unit.
